(19) United States
(12) Patent Application Publication
(10) Pub. No.: US 2008/0281517 A1
(43) Pub. Date: Nov. 13, 2008

(54) APPARATUS AND METHODS FOR REDUCING DATA TRANSMISSION IN WIRELESS CLIENT-SERVER NAVIGATION SYSTEMS

(76) Inventor: Ian Cummings, Ypsilanti, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/116,760

(22) Filed: May 7, 2008

Related U.S. Application Data
(63) Continuation-in-part of application No. 11/697,977, filed on Apr. 9, 2007.
(60) Provisional application No. 60/916,682, filed on May 8, 2007.

(51) Int. Cl. G01C 21/36

(52) U.S. Cl. 701/210

(57) ABSTRACT

Methods and apparatus reduce data transmission in a wireless client-server navigation system. In the preferred method, reduction of data sent is made possible by giving the user control over rerouting decisions. In many navigation systems, the navigator automatically generates a new route if a user strays from the route it provided. In a wireless client-server this is undesirable because of the increased cost or rerouting due to data transmission costs. On the other hand, providing an easy to use rerouting method is very important to customer satisfaction. In order to provide both data reduction and user satisfaction, when a user strays from the route provided, the navigator accepts user instructions as to how to handle rerouting. In this method the user is given the options of rerouting, suspending the current route until the user returns to it, or canceling the route. Only one of these options results in additional transmission of data.

### REFERENCE TO RELATED APPLICATIONS

This application is a continuation-in-part of U.S. patent application Ser. No. 11/697,977, filed Apr. 9, 2007. This application also claims priority to U.S. Provisional Patent Application Ser. No. 60/916,682, filed May 8, 2007. The entire content of each application is incorporated herein by reference.

### FIELD OF THE INVENTION

This invention relates generally to navigation systems and, in particular, to apparatus and methods for reducing data transmission in wireless client-server environments.

### BACKGROUND OF THE INVENTION

The engineering and business requirements of navigation by wireless client-server (WCS) navigators, in which route searches and map generation are performed at a central location then transmitted to mobile units, differ somewhat from those of standard standalone navigators. One major difference is that for WCS navigators, data transmission costs are a large part of the ongoing cost of operating the navigation system. In order to economically provide WCS navigation, it is important to minimize the amount of data transmitted while still meeting customers' navigation needs.

### SUMMARY OF THE INVENTION

This invention is directed to methods and apparatus for reducing data transmission in a wireless client-server navigation system. In the preferred method, reduction of data sent is made possible by giving the user control over rerouting decisions. In many navigation systems, the navigator automatically generates a new route if a user strays from the route it provided. In a wireless client-server this is undesirable because of the increased cost or rerouting due to data transmission costs. On the other hand, providing an easy to use rerouting method is very important to customer satisfaction.

According to this invention, in order to provide both data reduction and user satisfaction, when a user strays from the route provided, the navigator accepts user instructions as to how to handle rerouting. In this method the user is given the options of rerouting, suspending the current route until the user returns to it, or canceling the route. Only one of these options results in additional transmission of data.

A wireless client-server navigation system according to the invention includes a mobile unit and a central server. The mobile unit includes a wireless transmitter for transmitting a request for data representative of a map-related feature, a receiver for receiving the data representative of the map-related feature, and a display for displaying the feature on a map. The central server includes an input for receiving data describing map-related features in the form of line segments interconnecting points having coordinates, a receiver for receiving the request from the mobile unit, a processor for performing an operation on the data describing the map-related feature associated with the request by the mobile to generate data representative of the feature in a data-reduced format; and a transmitter for transmitting the data representative of the feature in the data-reduced format to the mobile unit. Other system-level aspects are disclosed and described in detail.

### BRIEF DESCRIPTION OF THE DRAWINGS

FIG. 1 shows a tile method according to the present invention;

FIG. 2 shows a tile method with a map divided into tiles with reference points;

FIG. 3 shows a tile method with Point A being represented as an offset from a reference point;

FIG. 4 shows a fitted curve embodiment as a true geographic feature;

FIG. 5 shows a fitted curve as a line approximation to the geographic feature;

FIG. 6 shows a curve constructed to approximate a route;

FIG. 7A is a chart that shows data to be transmitted for the line approximation of FIG. 6.

FIG. 7B is a chart that shows data to be transmitted for the curve approximation of FIG. 6;

FIG. 8 shows a fitted curve as a geographic feature shown to a user;

FIG. 9 shows a point removal embodiment according to the invention;

FIG. 10 shows points selected for removal;

FIG. 11 shows a point removal example as an approximation of a geographic feature;

FIG. 12 shows a point removal example generating a measure of the accuracy of the approximation;

FIG. 13 shows a navigator following a route;

FIG. 14 shows a navigator after the user has chosen to leave a route; and

FIG. 15 shows a query to the user as to his desires regarding rerouting.

### DETAILED DESCRIPTION OF THE INVENTION

The various embodiments described herein are intended to be used with a wireless client-server (WCS) navigation system. Such a system provides guidance in the form of maps, routes, and/or instructions, and
1) which has mobile clients used for requesting and receiving guidance,
2) which has a central server that houses databases of geographical information, and which generates guidance, and
3) wherein data is transmitted between the mobile clients and central server.

### Tiling Embodiment

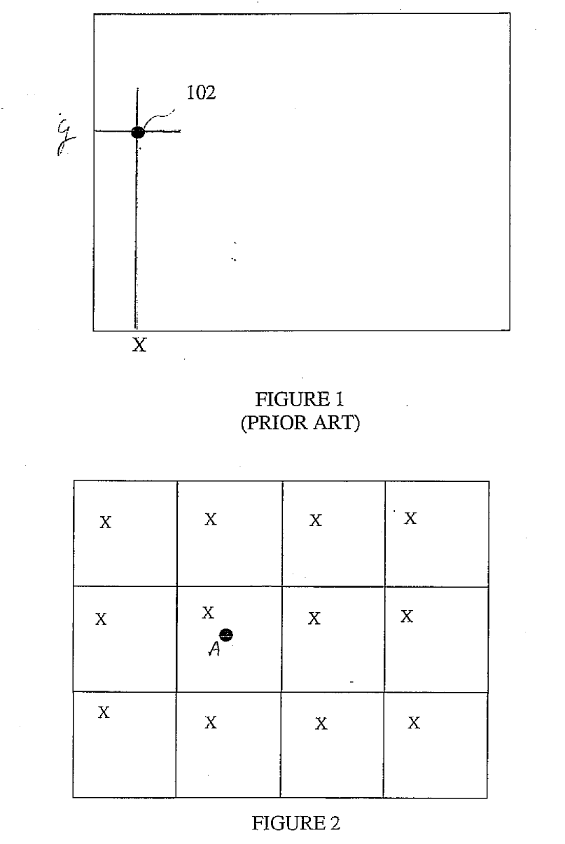

In existing navigation systems, geographic data is often generated and stored using highly accurate but data-intensive means. For example, in the commonly used shapefile format depicted in FIG. 1, each point 102 is stored as an (x,y) coordinate using the double float data format, requiring a total of 16 bytes.

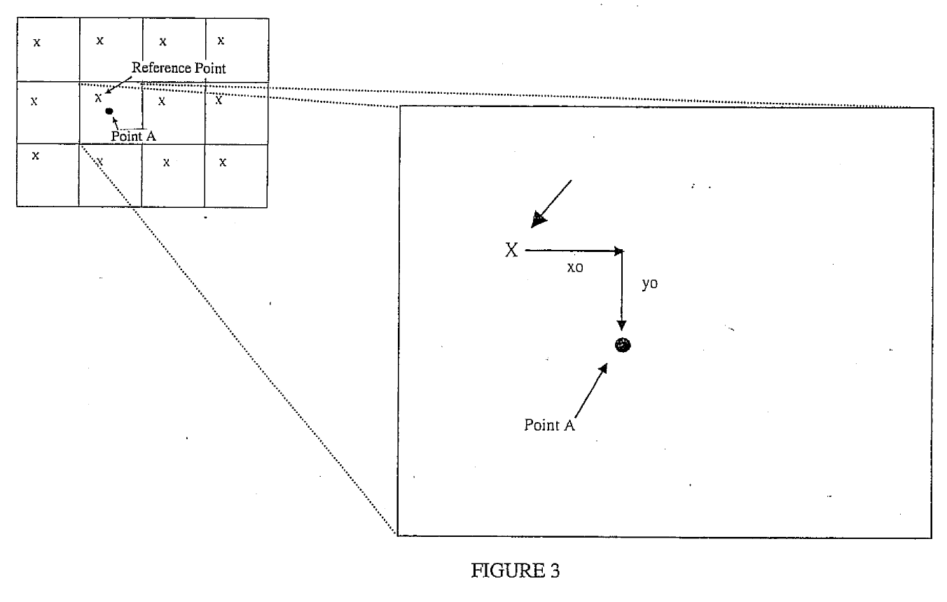

The tile method according to this invention uses a less data intensive method to preserve required accuracy while minimizing the amount of data transmitted. In the tile method, depicted in FIG. 2, a map is divided into a set of tiles. The tiles are generally of equal size, although this is not necessary. Each tile is assigned a reference point X, and the coordinates of each point A within each tile are then represented as a offset (xo, yo in FIG. 3) from the reference point. The tile method may be applied when a request for a map is received, or a tiled map may be generated then used for future map requests.

As an example of how this could provide benefits in data transmission, suppose points in a map are stored in shapefile format, requiring 16 bytes to represent each point. The map is divided up into tiles measuring one mile east-west by one mile north-south. Further suppose that it has been determined that users of the navigator require no greater resolution than 25 feet; meaning that if a feature is within 25 feet of where their navigator says, then it's good enough for them. A reference point is selected within the tile, and all points within the tile are represented as an offset from the reference location. In a one square mile tile, all locations can be measured as an offset from a reference point to within 25 feet by a set of data including x and y coordinates in 8 bit integer format, requiring 2 bytes total for each point, since 5280 feet/mile divided by 2̂8 is 20.625 feet.

In this example, 16 additional bytes of data are required to represent the reference point of each tile, but for each point within the tile, 14 bytes are saved. Thus if there is on average more than one point per tile, an overall reduction in data transmission can be achieved with the specific approach of this example.

The tile method also has the advantage of dividing data to be transmitted into discrete, easily manipulated units of data.

### Fitted Curve Embodiment

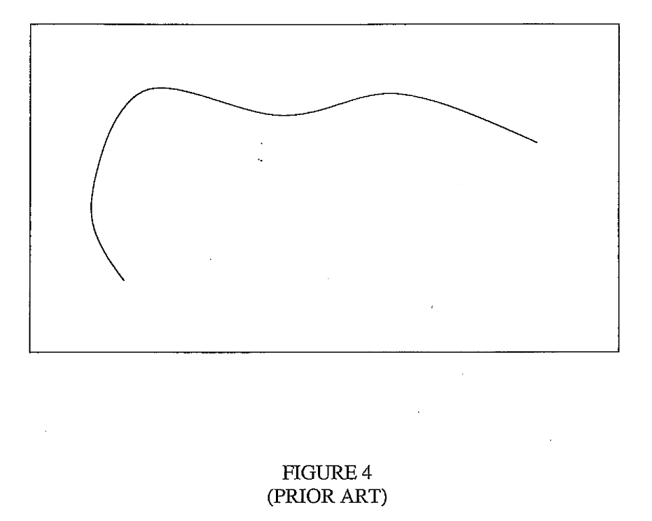

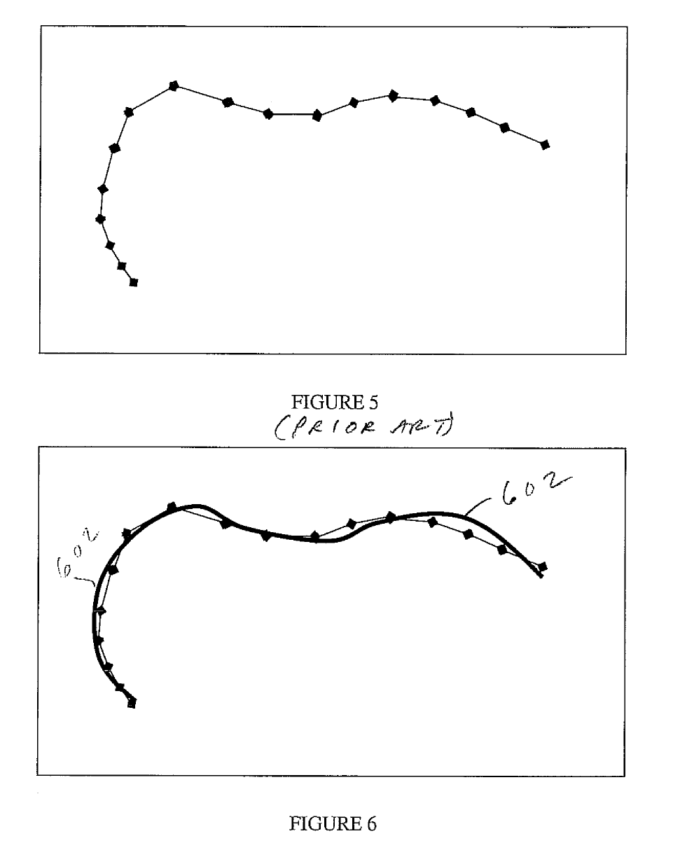

Many standard representations of geographical information are limited to the use of straight lines. When a curve such as that shown in FIG. 4 must be approximated, a large number of straight lines are used instead, as shown in FIG. 5. While this improves the accuracy of the map, in WCS navigators it also greatly increases the amount of map data that must be transmitted.

According to this invention, instead of transmitting all of the points of straight lines representing a curve, the navigation system transmits information from which a curve can be constructed that approximates the lines provided in the geographical information.

In the first step of this method, a curve such as 602 shown in FIG. 6 is generated that approximates lines provided in geographical information. A large number of curve construction methods are possible, including Bezier curves, other splines, polynomial curves, and fractals. This method is not intended to be limited to any particular method of generating curves. A measure of accuracy of the generated curve is defined and used to judge the suitability of the curve.

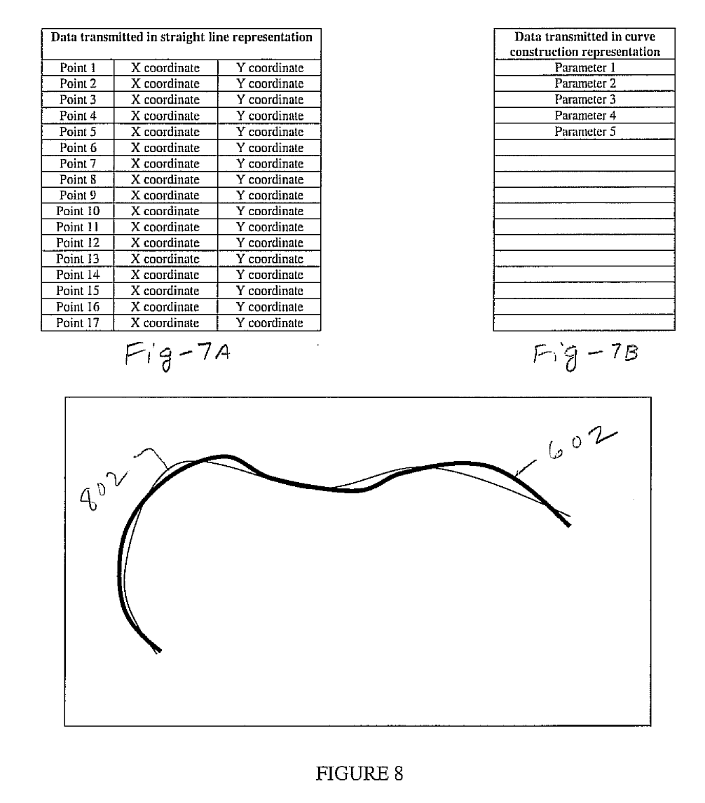

The information representing the curve is then transmitted from the server to the client. The information may be a set of points along the curve, or it may be another arbitrary representation. The type of curve and information about how it is to be reconstructed may also be transmitted, or it may have been previously provided to the client. The client receives the information and from it constructs a graphical representation of the curve for use of the customer. FIG. 7A is a chart that shows data to be transmitted for line approximation, versus the curve approximation in FIG. 7B. FIG. 8 shows the approximation 602 versus the actual geographic feature 802. Again, information representing the curve may be generated at the time a user requests map information or it may be generated at an earlier time and stored for future use.

### Point Removal Embodiment

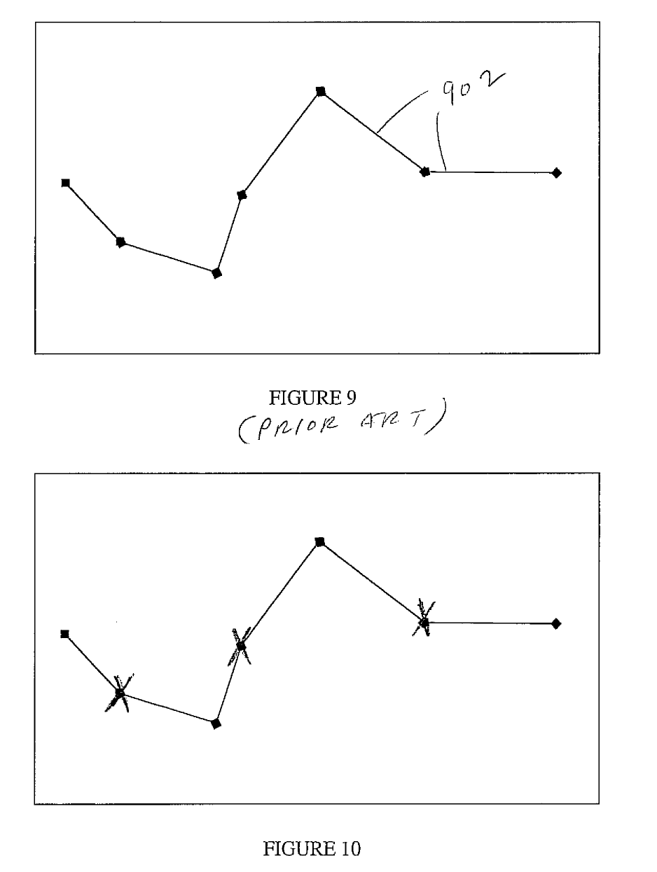

Many standard representations of geographical information are limited to the use of straight lines. When a curve must be approximated, a large number of straight lines 902 are used instead, as shown in FIG. 9. While this improves the accuracy of the map, in WCS navigators it also greatly increases the amount of map data that must be transmitted.

Many customers do not require the full accuracy provided by straight line approximations, particularly when maps are displayed that show large areas. For this reason it is useful to remove points of the representation if geographical data.

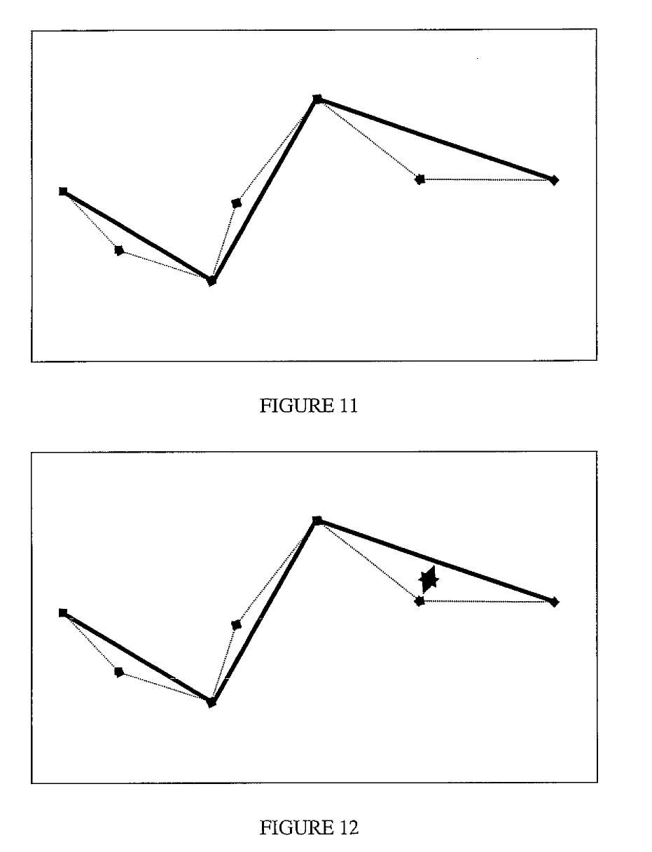

In this method:
1) A set of line segments representing a geographical feature is considered.
2) One or more points defining the line segments are identified for removal (the Xs in FIG. 10).
3) A new set of line segments is constructed using the remaining points, which approximates the original set of line segments (FIG. 11).
4) A measure is generated of the nearness of the new set of line segments to the old set of line segments.
5) The measure is compared to a standard, and if the standard is met or exceeded, then the new set of line segments is used rather than the old set. Note that the standard may vary depending on map scale, user preferences, or other criteria. In FIG. 12, for example, the star-shaped symbol is used to show a relatively large deviation from actual which may not conform to a given standard.
6) The points of the new line segments are sent from the server to the client
7) A graphical representation of the new line segments are constructed by the client.

This method may be applied when a user requests a map, or various approximate maps may be generated and later used upon user request.

### Data Compression Embodiment

In order to reduce the amount of data sent with a WCS navigator, a variety of data compression algorithms may be used. Common examples of such algorithms include the Lempel-Ziv algorithm, the DEFLATE algorithm, the Lempel-Ziv-Welch algorithm, and LZ-Renau algorithm, although this method is not intended to be limited to these particular algorithms. The data compression method is to use a data compression algorithm to reduce the amount of data transmitted in a WCS navigator.

### Rerouting Data Transmission Optimization

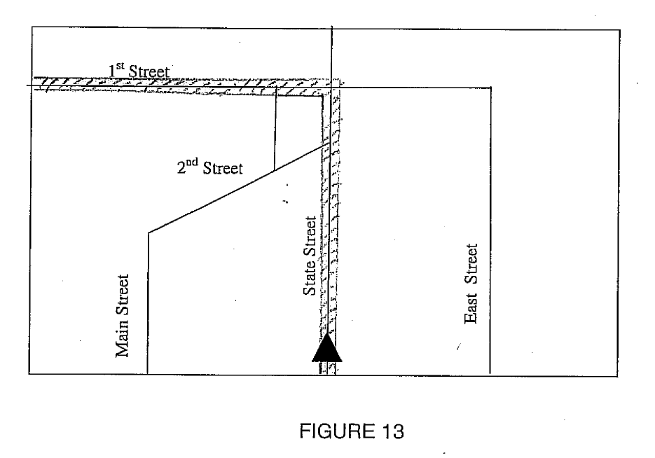

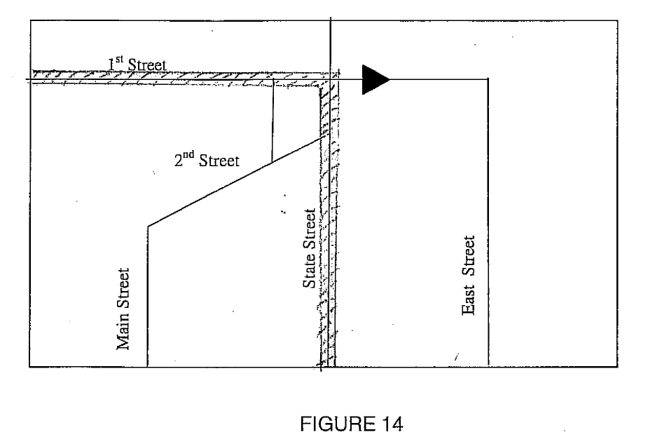

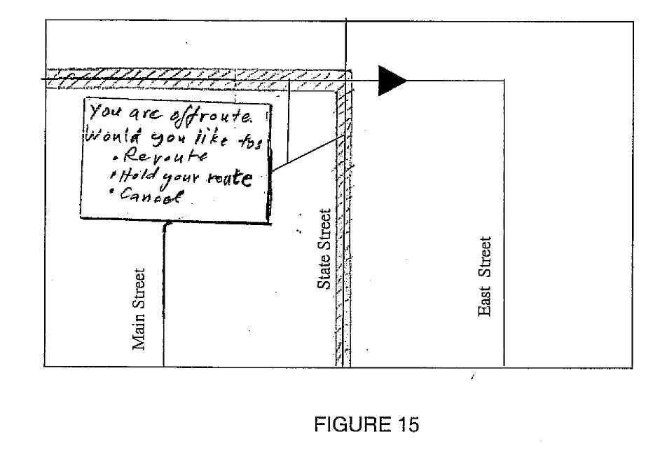

When a user has been following a route provided by a navigator, as shown in FIG. 13, and the navigator detects that the user has strayed from the route, as shown if FIG. 14, the user is informed that they are off-course. According to this embodiment, to conserve on data transmission, the navigator allows the user to communicate his preferences with regard to rerouting. Three options are provided: canceling the route, not canceling the route but ceasing to provide guidance until the user has returned to the route, and generating a new route to the desired destination. The options may be presented visually, as in FIG. 15, audibly, or not at all. The user's command as to how to proceed may be indicated audibly or via the navigator's controls.

I claim:

1. A method of rerouting in a navigation system, comprising:
providing guidance to a user along a route to a destination;
determining if a departure from the route has occurred and, if it has, notifying the user;
inputting an instruction from the user in response to the notification, the options including:
canceling the route,
generating a new route to the destination incorporating the departure, and suspending guidance until the user has returned to the route.

2. The method of claim 1, wherein the guidance is provided in the form of text, imagery, video, symbols, or audio.

3. The method of claim 1, wherein the options are options are presented to the user.

4. The method of claim 3, wherein the options are provided in the form of text, imagery, video, symbols, or audio.

5. The method of claim 1, wherein the are carried out in a wireless client-server navigation system of the type wherein the users is a mobile client requesting and receiving guidance from a central server accessing a database of geographical information.
